(19) United States
(12) Patent Application Publication
(10) Pub. No.: US 2010/0180477 A1
(43) Pub. Date: Jul. 22, 2010

(54) Marking Apparatus For Dishware

(76) Inventor: Suzanne Monaghan, Fredericksburg, VA (US)

Correspondence Address: L.C. BEGIN & ASSOCIATES, PLLC, 510 HIGHLAND AVENUE, PMB 403, MILFORD, MI, 48381, US

(21) Appl. No.: 12/691,187

(22) Filed: Jan. 21, 2010

Related U.S. Application Data
(60) Provisional application No. 61/146,006, filed on Jan. 21, 2009.

(51) Int. Cl. G09F 3/18; G09F 3/00

(52) U.S. Cl. 40/324

(57) ABSTRACT

One embodiment of a marking apparatus for a dishware may include a central member having a first peripheral edge portion and a second peripheral edge portion. The marking apparatus may further include a first support member extending outwardly from the first peripheral edge portion. Furthermore, the marking apparatus may include a second support member extending outwardly from the second peripheral edge portion. The first support member and the second support member may configure a slot therebetween to receive a portion of the dishware. Each of the first support member and the second support member may include an outer surface and an inner surface. The outer surface of at least one of the first support member and the second support member may include at least one indicium displayed thereon.

### CROSS REFERENCE TO RELATED APPLICATION

This application claims the benefit of U.S. Provisional Application No. 61/146,006 filed on Jan. 21, 2009, the disclosure of which is incorporated by reference.

### FIELD OF THE DISCLOSURE

The present disclosure generally relates to a marking apparatus for a dishware.

### BACKGROUND OF THE DISCLOSURE

Dishware, such as plates and trays, are used by various individuals at places such as restaurants, hotels and other establishments, for serving and/or consuming a variety of food products. Generally, in restaurants and other establishments, the food products are prepared by cooks or chefs, and are served by waiters to consumers. These food products may include various ingredients, such as gluten, dairy products, fish products, egg products and the like. Few of these ingredients may act as allergens for certain individuals.

However, some of these ingredients may act as allergens for certain individuals. That is, certain consumers may have an allergy or sensitivity to certain ingredients that may be contained in or used in preparing the food products. Accordingly, such consumers wish to be served with a food product that is free from such allergens. However, it may be difficult for a consumer to receive a food product which is free from an allergen, when eating at a public place. Moreover, it also becomes difficult for chefs and waiters to be sure that the food product being served to the consumer is free from the allergen.

### SUMMARY OF THE DISCLOSURE

One embodiment of a marking apparatus for a dishware may include a central member having a first peripheral edge portion and a second peripheral edge portion opposite to the first peripheral edge portion. The marking apparatus may further include a first support member extending outwardly from the first peripheral edge portion of the central member. Further, the marking apparatus may also include a second support member extending outwardly from the second peripheral edge portion of the central member, such that the first support member and the second support member configure a slot therebetween to receive a peripheral portion of the dishware.

Each of the first support member and the second support member may include an outer surface and an inner surface. The outer surface of at least one of the first support member and the second support member may include at least one indicium displayed thereon. The inner surface of the each of the first support member and the second support member may be capable of engaging the peripheral portion of the dishware, when the peripheral portion is received within the slot for attaching the marking apparatus to the dishware.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a perspective view of one embodiment of a marking apparatus;

FIG. 2 is a perspective view of marking apparatus of FIG. 1, attached to a dishware;

FIG. 3 depicts an alternate embodiment of a marking apparatus; and,

FIG. 4 depicts another alternate embodiment of a marking apparatus.

### DETAILED DESCRIPTION OF THE DISCLOSURE

The exemplary embodiments described herein in detail for illustrative purposes are subject to many variations in structure and design. It should be emphasized, however, that the present disclosure is not limited to a particular marking apparatus, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. The terms such as “first” and “second” and other variations thereof as used herein, do not denote an order, elevation or importance, but rather used signify the presence of at least one of the referenced item. Further, the terms, “a” and “an” herein do not denote a limitation of quantity, but rather denote the presence of at least one of the referenced item.

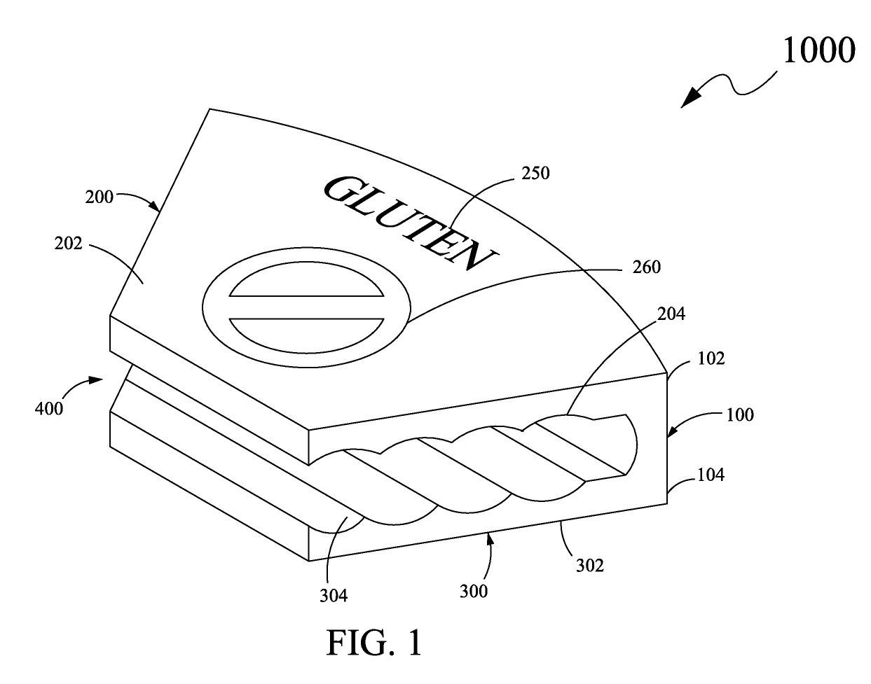

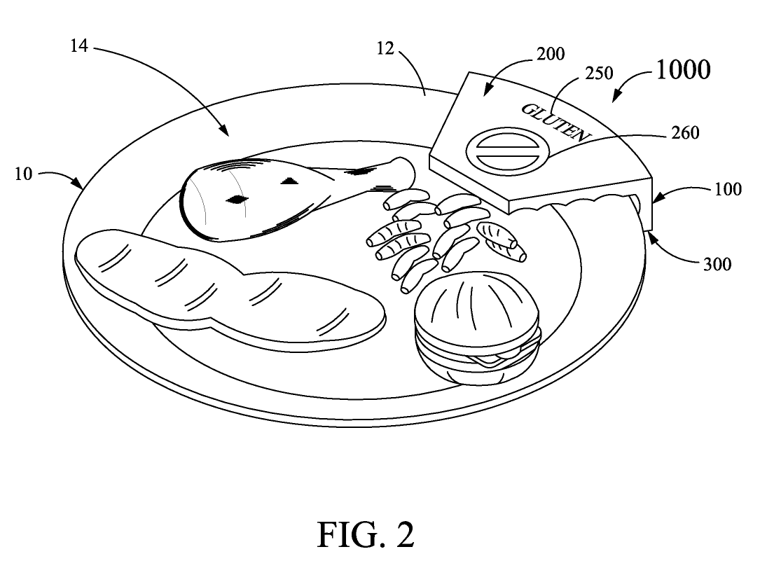

Referring to FIGS. 1-2, one embodiment of a marking apparatus 1000, which may be used for marking a dishware 10 is shown. The dishware 10 may be a plate. In another form, the dishware 10 may be either a tray or any form of a dishware used for serving and or consuming any food product.

The marking apparatus 1000 may include a central member 100 having a first peripheral edge portion 102 and a second peripheral edge portion 104 opposite to the first peripheral edge portion 102. The central member 100 may be conformed according to a peripheral portion 12 of the dishware 10 (as shown in FIG. 2). The central member 100 may be composed of a heat-resistant material. The central member 100 may be formed from a “dishwasher-safe” material. As used herein, the term “dishwasher-safe” is understood to mean that any color, text, image, or combination thereof imparted to the material will not wear off or wash off to any appreciable degree as a result of cycling the material through a dishwasher. The central member 100 may be formed from a rubber material. Of course, the central member 100 may instead be manufactured from any other suitable material without departing from the scope of the present disclosure. In addition, the central member 100 may be configured to have a variety of colors, such as red, blue or green, or combinations thereof.

The marking apparatus 1000 may further include a first support member 200. The first support member 200 may extend outwardly from the first peripheral edge portion 102 of the central member 100. The first support member 200 may include an outer surface 202 and a toothed inner surface 204.

The outer surface 202 of the first support member 200 may include at least one indicium displayed thereon. As used herein, the term “indicium” is understood to denote a sign or something that serves to indicate. The at least one indicium may include a text message 250. The text message 250 may correspond to a food product 14 carried by the dishware 10. The text message 250 may indicate the absence of an ingredient, such as gluten, diary and the like, in the food product 14 carried by the dishware 10. Such an ingredient may be an allergen for a consumer of the food product 14. For example, the text message 250 may state “GLUTEN” to indicate that the food product 14 may be free from gluten and is specific for a person who is allergic to gluten. In another form, the text message 250 may indicate the presence of the ingredient in the food product 14 carried by the dishware 10.

The at least one indicium may also optionally include an image 260. The image 260 may correspond to a food product or an ingredient in the food product 14 carried by the dishware 10. For example, the image 260 may indicate the presence of the ingredient, such as gluten, diary and the like, in the food product 14 carried by the dishware 10. This may be useful in instances where, for example, a type of food product contains a potential allergen that a consumer may normally assume would not be present in the food product. The allergen may be present because of the way the food product was prepared or may reside in an additive applied to the food product, for example. In another form, the image 260 may indicate the absence of the ingredient in the food product 14 carried by the dishware 10. The food product 14 may include one or more food items.

Alternatively, the at least one indicium may include both text and an image which combine to indicate the presence or absence of a food product or an ingredient of a food product.

In the embodiment shown in FIGS. 1 and 2, the text 250 indicates the type of potential allergen while the symbol or image 260 (or lack thereof) indicates the presence (or absence) of the potential allergen. That is, when the image 260 is present, the message conveyed to the consumer is that the type of potential allergen indicated by the text 250 is not present in the food product carried by the dishware 10 (or in food products intended to be carried by the dishware). Similarly, when the image 260 is absent, the message conveyed to the consumer is that the type of potential allergen indicated by the text 250 is (or may be) present in the food product carried by the dishware 10 (or in food products intended to be carried by the dishware).

For the purpose of the description, the dishware 10 is shown to carry the food product 14, however the dishware 10 may also be marked prior to carrying any food product. Accordingly, the text message 250 and/or the image 260 may correspond to a food product (not shown), which is intended to be carried by the dishware 10. The text message 250 and/or the image 260 may indicate the absence of an ingredient in the food product intended to be carried by the dishware 10. The ingredient may be an allergen to a consumer of the food product intended to be carried by the dishware 10. In another form, the text message 250 and/or the image 260 may indicate the presence of the ingredient in the food product intended to be carried by the dishware 10.

The toothed inner surface 204 of the first support member 200 may be capable of gripping and securing to the peripheral portion 12 of the dishware 10, thereby attaching the marking apparatus 1000 to the dishware 10.

The first support member 200 may be formed from a heat-resistant material. The first support member 200 may be formed from a “dishwasher-safe” material. As used herein, the term “dishwasher-safe” is understood to mean that any color, text, image, or combination thereof imparted to the material will not wear off or wash off to any appreciable degree as a result of cycling the material through a dishwasher. The first support member 200 may be formed from a rubber material. Alternatively, the first support member 200 may be formed from another material specified so as to provide frictional engagement with the dishware to aid in retaining the marking apparatus 1000 to the dishware. Of course, the first support member 200 may instead be manufactured from any other suitable material without departing from the scope of the present disclosure. In addition, the first support member 200 may be configured to have any of a variety of colors, such as red, blue or green, or combinations thereof, which may be similar to the color of the central member 100.

Further, the marking apparatus 1000 may include a second support member 300. The second support member 300 may extend outwardly from the second peripheral edge portion 104 of the central member 100. The second support member 300 may include an outer surface 302 and a toothed inner surface 304.

The outer surface 302 of the second support member 300 may optionally include at least one indicium (not shown) displayed thereon. The at least one indicium may include a text message, which may be similar to the text message 250. The text message may correspond to the food product 14 or to an ingredient of the food product carried by the dishware 10. The text message may alternatively correspond to the food product or to an ingredient of the food product intended to be carried by the dishware 10. Further, the outer surface 302 may include an image (not shown), which may be similar to the image 260. In another form, the outer surface 302 may include at least one indicium for the food product or an ingredient of the food product intended to be carried by the dishware 10. Optionally, outer surface may include an image, text, or combination thereof indicating the name of a restaurant or other location where the food product is served.

The toothed inner surface 304 of the second support member 300 may be capable of securing and gripping to the peripheral portion 12 of the dishware 10, thereby attaching the marking apparatus 1000 to the dishware 10.

The second support member 300 may be formed from a heat-resistant material. The second support member 300 may be formed from a “dishwasher-safe” material. As used herein, the term “dishwasher-safe” is understood to mean that any color, text, image, or combination thereof imparted to the material will not wear off or wash off to any appreciable degree as a result of cycling the material through a dishwasher. The second support member 300 may be formed from a rubber material. Alternatively, the second support member 300 may be formed from another material specified so as to provide frictional engagement with the dishware to aid in retaining the marking apparatus 1000 to the dishware. Of course, the second support member 300 may instead be manufactured from any other suitable material without departing from the scope of the present disclosure. In addition, the second support member 300 may be configured to have any of a variety of colors, such as red, blue or green, or combinations thereof, which may be similar to the color of the central member 100 and/or the first support member 200.

As best shown in FIG. 1, the first support member 200 and the second support member 300 configure a slot 400 therebetween. The slot 400 may be adapted to receive the peripheral portion 12 of the dishware 10 (as shown in FIG. 2). The toothed inner surfaces 204 and 304 may be capable of gripping and securing to the peripheral portion 12 of the dishware 10 thereby attaching the marking apparatus 1000 to the dishware 10. The marking apparatus 1000 upon being attached to the dishware 10 enables in marking the dishware 10 to signify either the presence or the absence of the ingredient from the food product 14 that may be carried by the dishware 10 or the food product intended to be carried by the dishware 10.

In embodiments disclosed herein, any of a variety of words, symbols, other indicia or suitable combinations thereof may be positioned on the marking apparatus 1000 to convey the presence or absence of any of a variety of food products or ingredients or other substances contained in the food products carried on the dishware. For example, only text may be used to indicate the absence or presence of the food product or food product ingredient. Alternatively, only one or more symbols or images may be used to indicate the absence or presence of the food product or food product ingredient. Alternatively, as previously described, a combination of suitable text and symbols may be used to indicate the absence or presence of the food product or food product ingredient. Any text, symbols or images, or combinations thereof suitable for conveying the desired message may be used.

In another alternative embodiment, either text alone, one or more images alone, or a combination of text and images are used to denote multiple separate and different features of the food product rather than a single feature (for example, the presence or absence of a potential allergen).

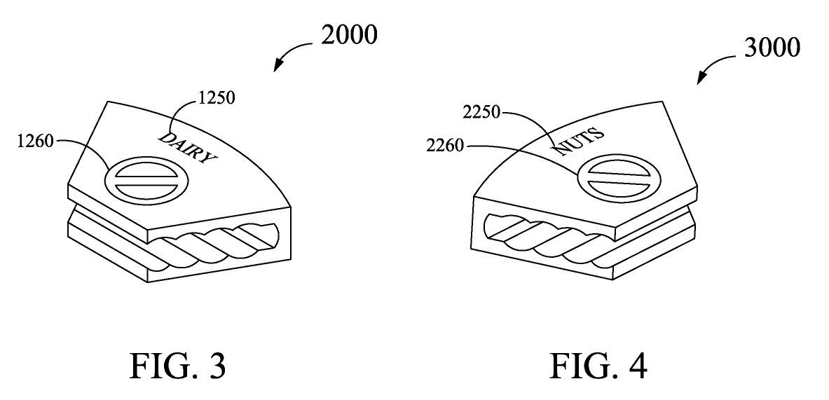

FIG. 3 and FIG. 4 depict alternative embodiments of a marking apparatus for a dishware. Specifically, FIG. 3 shows a marking apparatus 2000 and FIG. 4 shows a marking apparatus 3000. The marking apparatus 2000, and the marking apparatus 3000 may be structurally and functionally similar to the marking apparatus 1000, therefore for the sake of brevity, the description of the same has been omitted. However, the marking apparatus 2000 may include a text message 1250, which states “DAIRY,” and an image 1260, which, taken in conjunction with the text message 1250, indicates “NO DAIRY”. Similarly, the marking apparatus 3000 may include a text message 2250, which indicates “NUTS,” and an image 2260, which, taken in conjunction with the text message 2250, indicates “NO NUTS”, Alternatively, as previously described, any desired image (or images), text, or combination thereof may be arranged on the marking apparatus 2000 to indicate the absence or presence of potential allergens such as eggs, dairy products, or gluten.

In use, the peripheral portion 12 of the dishware 10 may be received in the slot 400 of the marking apparatus 1000, such that the peripheral portion 12 gets attached to the first support member 200 and the second support member 300, thereby attaching the marking apparatus 1000 to the dishware 10. The at least one indicium on the marking apparatus 1000 may correspond to the food product 14 carried by the dishware 10. The at least one indicium may be or include the text message 250. Further, the at least one indicium may be or include the image 260. More specifically, the text message 250 or the image 260 may indicate the absence of “GLUTEN” from the food product 14 carried by the dishware 10. Accordingly, the marking apparatus 1000 upon being attached to the dishware 10 enables an individual, such as a restaurant operator, a waiter, or a consumer of the food product 14, to be informed that the food product 14 prepared by a chef, lacks gluten or that any other food product containing gluten should be precluded from being carried by the dishware 10.

Accordingly, the marking apparatus 1000 provides the consumer a convenient way of marking the dishware 10 for communicating their food preferences of being served with a food product free from (or contains) a certain ingredient. Also, the marking apparatus 1000 provides restaurant operators, waiters, and chefs a convenient way of marking a dishware 10 for communicating that a food product contained in the dishware 10 is free from (or contains) a certain ingredient.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A marking apparatus for a dishware, the marking apparatus comprising:
a central member having a first peripheral edge portion and a second peripheral edge portion opposite to the first peripheral edge portion;
a first support member extending outwardly from the first peripheral edge portion of the central member; and,
a second support member extending outwardly from the second peripheral edge portion of the central member, such that the first support member and the second support member configure a slot therebetween to receive a portion of the dishware,
wherein each of the first support member and the second support member comprises an outer surface and an inner surface, the outer surface of at least one of the first support member and the second support member comprising at least one indicium displayed thereon, the inner surface of the each of the first support member and the second support member being capable of engaging the portion of the dishware when the portion is received within the slot for attaching the marking apparatus to the dishware.

2. The marking apparatus of claim 1, wherein the at least one indicium comprises text, the text corresponding to one of a food product carried by the dishware and a food product intended to be carried by the dishware.

3. The marking apparatus of claim 2, wherein the text indicates the absence of an ingredient from the food product carried by the dishware.

4. The marking apparatus of claim 2, wherein the text indicates the absence of an ingredient from the food product intended to be carried by the dishware.

5. The marking apparatus of claim 2, wherein the text indicates the presence of an ingredient from food product carried by the dishware.

6. The marking apparatus of claim 2, wherein the text indicates the presence of an ingredient in the food product intended to be carried by the dishware.

7. The marking apparatus of claim 1, wherein the at least one indicium comprises an image, the image corresponding to one of a food product carried by the dishware and a food product intended to be carried by the dishware.

8. The marking apparatus of claim 7, wherein the image indicates the absence of an ingredient from the food product carried by the dishware.

9. The marking apparatus of claim 7, wherein the image indicates the absence of an ingredient from the food product intended to be carried by the dishware.

10. The marking apparatus of claim 7, wherein the image indicates the presence of an ingredient in the food product carried by the dishware.

11. The marking apparatus of claim 7, wherein the image indicates the presence of an ingredient in the food product intended to be carried by the dishware.

12. The marking apparatus of claim, wherein each of the central member, the first support member and the second support member is composed of a rubber material.

13. The marking apparatus of claim 1, wherein each of the central member, the first support member and the second support member is composed of a heat-resistant material.

14. The marking apparatus of claim 1, wherein the inner surface of at least one of the first support member and the second support member includes at least one tooth formed thereon.

15. The marking apparatus of claim 2, wherein the at least one indicium further comprises an image, the text message in combination with the image corresponding to one of a food product carried by the dishware and a food product intended to be carried by the dishware.

16. The marking apparatus of claim 7, wherein the at least one indicium further comprises text, the text in combination with the image corresponding to one of a food product carried by the dishware and a food product intended to be carried by the dishware.

17. The marking apparatus of claim wherein the at least one indicium denotes a location where a food product, is served.

18. The marking apparatus of claim 1, wherein each of the central member, the first support member and the second support member is composed of a dishwasher-safe material.
